(19) United States
(12) Patent Application Publication
(10) Pub. No.: US 2020/0061756 A1
(43) Pub. Date: Feb. 27, 2020

(54) CMT TECHNOLOGY WITH FLUX-CORED WIRE FEED

(71) Applicant: Siemens Aktiengesellschaft, München (DE)

(72) Inventors: Nikolai Arjakine, Berlin (DE); Torsten Jokish, Neuenhagen bei Berlin (DE); Bernd Berbaum, Falkensee (DE)

(21) Appl. No.: 16/466,229

(22) PCT Filed: Nov. 9, 2017
(86) PCT No.: PCT/EP2017/078724

§ 371 Date: Jun. 3, 2019

(30) Foreign Application Priority Data
Dec. 9, 2016 (DE) 10 2016 224 560.0

(51) Int. Cl. B23K 35/02; B23K 9/173; B23P 6/00; B23P 6/04; B23K 9/04

(52) U.S. Cl. CPC B23K 35/0266; B23K 9/173; B23K 2101/001; B23P 6/045; B23K 9/04; B23P 6/007

(57) ABSTRACT

Continuous cracks can be optimally repaired using CMT technology by using a fluxed-core wire of solder material with a filling consisting of or comprising solder material and base material.

### CROSS-REFERENCE TO RELATED APPLICATIONS

This application claims priority to PCT Application No. PCT/EP2017/078724, having a filing date of Nov. 9, 2017, which is based off of DE Application No. 10 2016 224 560.0, having a filing date of Dec. 9, 2016, the entire contents both of which are hereby incorporated by reference.

### FIELD OF TECHNOLOGY

The following relates to CMT technology (Cold Metal Transfer), in which a flux-cored wire of base material and solder material is used for welding, in particular for repair.

### BACKGROUND

In the case of operationally stressed components produced from polycrystalline solidified nickel-based superalloys with an intermetallic phase as the majority component, it is endeavored to repair through-cracks with the same material in order to maintain the thermomechanical properties of the components to be repaired in the region of the parent material. Small cracks are usually closed by means of high-temperature soldering. But if these cracks become too large (>500 μm), soldering by conventional narrow-gap soldering is no longer possible. Because of an oxide film on the surface of the crack, a laborious cleaning process (FIC) is also necessary in order to free the cracks of the oxides.

### SUMMARY

An aspect relates to therefore solve this problem.

### BRIEF DESCRIPTION

Some of the embodiments will be described in detail, with reference to the following figures, wherein like designations denote like members, wherein:

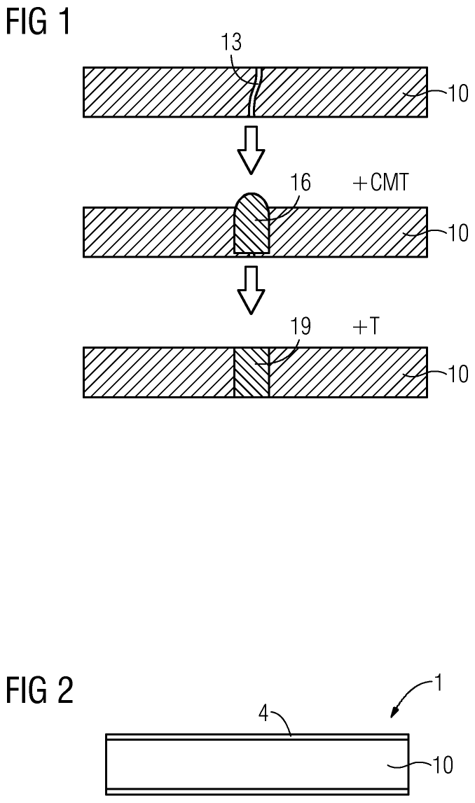

FIG. 1 shows the method according to embodiments of the invention and the flux-cored wire in a schematic representation: and

FIG. 2 shows the method according to embodiments of the invention and the flux-cored wire in a schematic representation.

The figures and the description only represent exemplary embodiments of the invention.

### DETAILED DESCRIPTION

FIG. 1 shows a substrate 10, for example as a wall which has a through-crack 13. Embodiments of the invention are not restricted to a wall.

The substrate 10 or the wall comprises a nickel- or cobalt-based alloy.

The crack 13 is filled with welding material 16 by CMT welding.

FIG. 2 shows a cross section through a flux-cored wire 1, which represents the welding material 16 and is used in CMT technology.

The flux-cored wire 1 has a sheath 4 of a solder material, while inside the sheath 4 there is a flux 7 of the solder material and the base material of the substrate 10.
Solder material means in this connection that the solder material has a melting temperature lower by at least 10 K, in particular by 20 K, than the base material of the substrate 10.
The proportion of solder material in the flux 7 is at least 10% by weight.

Solder material or clear differences means that, with respect to the base material, there is or is not a further alloying element or the proportion by weight, by volume, mol % or at % differs by at least 10%, in particular by at least 20%.

According to FIG. 1, after the deposition welding 16 (+CMT), a thermal treatment (+T) brings about a kind of soldering process, which makes it possible for the crack 13 to be closed completely through the entire wall thickness of the crack.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for welding a substrate, in which CMT technology with a flux-cored wire is used,
wherein in the interior of a sheath of the flux-cored wire there is a flux with a composition
which clearly differs from the material of the sheath and the material of the wire to be welded.

2. The method as claimed in claim 1,
in which the flux-cored wire has a sheath of a solder material and
the flux comprises a mixture of solder material and base material of a substrate to be welded,
wherein solder material means that it has with respect to the base material a lower melting temperature by at least 10 K, or by at least 20 K.

3. The method as claimed in claim 1,
in which through-cracks are welded.

4. The method as claimed in claim 1,
in which a thermal treatment is carried out as a final process,
in which a soldering of the welded location is performed.

5. The method as claimed in claim 1,
in which a wall of a turbine component, in particular of a nickel-based superalloy, is welded.

6. The method as claimed in claim 1,
in which the proportion of the solder material in the flux is at least 10% by weight.
